(19) United States
(12) Patent Application Publication
(10) Pub. No.: US 2026/0148968 A1
(43) Pub. Date: May 28, 2026

(54) COMPOSITE ELECTRODE PARTICLE COATED WITH GRANULAR SILICON STRUCTURE, CARBON LAYER AND ZINC OXIDE

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen, CN (CN)

(21) Appl. No.: 18/963,559

(22) Filed: Nov. 28, 2024

(51) Int. Cl. H01M 4/36; H01M 4/02; H01M 4/38; H01M 4/48; H01M 4/583; H01M 4/62

(52) U.S. Cl. CPC H01M 4/366; H01M 4/386; H01M 4/483; H01M 4/583; H01M 4/625; H01M 2004/021; H01M 2004/027

(57) ABSTRACT

A composite electrode particle coated with a granular silicon structure, a carbon layer and a zinc oxide layer is used in an electrode of a solid-state or semi-solid battery. The composite electrode particle includes a porous carbon particle having a plurality of holes. The carbon layer is an amorphous carbon layer coated on an outer surface of the porous carbon particle. The amorphous carbon layer is a continuous structure which serves to inhibit an expansion of the composite electrode particle. A plurality of silicon particles are dispersed within the amorphous carbon layer. An outer surface of a part of the silicon particles is coated with a silicon oxide layer. The zinc oxide layer is coated on an outer side of the amorphous carbon layer and is a continuous structure which serves to protect and keep an integrity of the composite electrode particle.

### FIELD OF THE INVENTION

The present invention is related to battery electrode material, and in particular to a composite electrode particle coated with a granular silicon structure, a carbon layer and zinc oxide.

### BACKGROUND OF THE INVENTION

A typical battery includes a positive electrode and a negative electrode. The negative electrode of a solid-state or semi-solid battery includes a negative electrode substrate and a negative electrode slurry layer. The negative electrode slurry layer includes a negative electrode slurry and a plurality of negative electrode particles. The negative electrode particles must be either additionally conductive or electrically conductive to allow free electrons to migrate through the negative electrode slurry without consuming too much energy due to internal resistance.

The negative electrode particles are dispersed within the negative electrode slurry and an outer surface of each negative electrode particle is coated with silicon particles. In the chemical reaction of the battery, the lithium ions will enter into the silicon particles to expand the size of the silicon particle, wherein the expanded size may be up to 400 times the original size of the silicon particle. Therefore, the size of the negative electrode particles will change dramatically, and such a large size expansion will break down the electrode particles, resulting in a degradation of the battery's performance.

### SUMMARY OF THE INVENTION

Accordingly, for improving above mentioned defects in the prior art, the object of the present invention is to provide a composite electrode particle coated with a granular silicon structure, a carbon layer and zinc oxide, wherein the silicon particles and the amorphous carbon layer are coated on the outer surface of the porous carbon particle. The silicon particles coated with the silicon oxide layer has a lower coefficient of thermal expansion and has a high binding ability, which inhibits the expansion of the composite electrode particle to prevent the composite electrode particle from rupturing. The amorphous carbon layer has a high conductivity and serves to inhibit an expansion of the composite electrode particle to prevent the composite electrode particle from rupturing due to a volumetric expansion when the lithium ions fill on the composite electrode particle. The outer side of the amorphous carbon layer is further coated with the zinc oxide layer which has a high conductivity and has the ductility similar to that of metals. When the lithium ions fill the silicon particles and expand the size of the silicon particles, the zinc oxide layer serves to protect the structure inside by the high ductility. As a result, by above multi-layer coating structure, the breakage rate of composite electrode particle can be greatly reduced.

To achieve above object, the present invention provides a composite electrode particle coated with a granular silicon structure, a carbon layer and zinc oxide; the composite electrode particle being used in an electrode of a solid-state or semi-solid battery; the composite electrode particle comprising: a porous carbon particle having a plurality of holes; the carbon layer being an amorphous carbon layer coated on an outer surface of the porous carbon particle; the amorphous carbon layer being a continuous structure formed by amorphous carbon; the amorphous carbon layer serving to inhibit an expansion of the composite electrode particle to prevent the composite electrode particle from rupturing when lithium ions fill on the composite electrode particle; a plurality of silicon particles are dispersed within the amorphous carbon layer; an outer surface of a part of the silicon particles being coated with a silicon oxide layer formed by SiOₓ, wherein 0<x≤2; and the zinc oxide (ZnO) layer being coated on an outer side of the amorphous carbon layer; the zinc oxide layer is a continuous structure formed by a plurality of zinc oxide particles; and wherein when the lithium ions fill the silicon particles and expand the size of the silicon particles, the zinc oxide layer serves to protect the composite electrode particle by a specific ductility to keep an integrity of the composite electrode particle.

### BRIEF DESCRIPTION OF THE DRAWINGS

FIG. 1 is a cross-section view showing the structure of the composite electrode particle of the present invention.

FIG. 2 is a schematic view showing the porous carbon particle of the present invention.

FIG. 3 is a schematic view showing the full structure and a partial structure of the composite electrode particle of the present invention.

FIG. 4 is a schematic view showing the silicon particles and the silicon oxide layer of the present invention.

FIG. 5 is a schematic view showing the carbon-nanotubes-coated composite electrode particle of the present invention.

FIG. 6 is a schematic view showing an application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

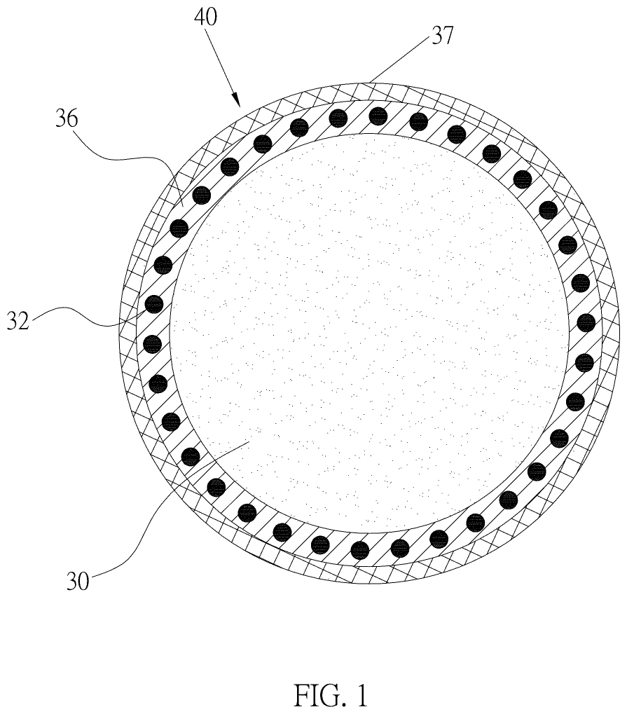

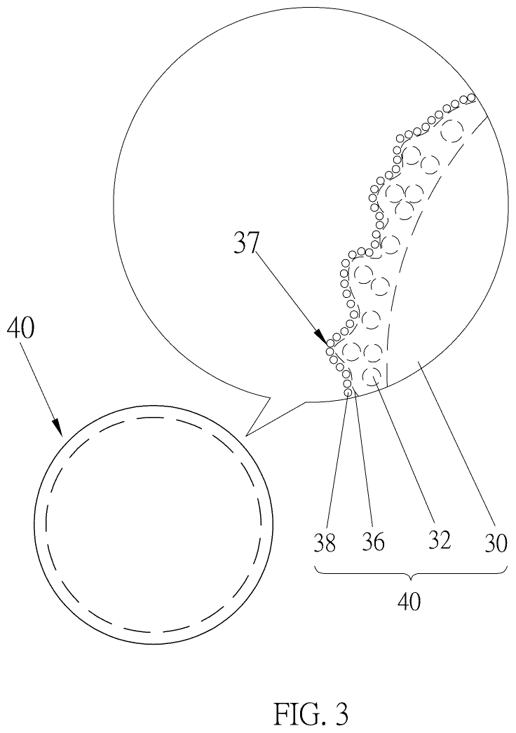

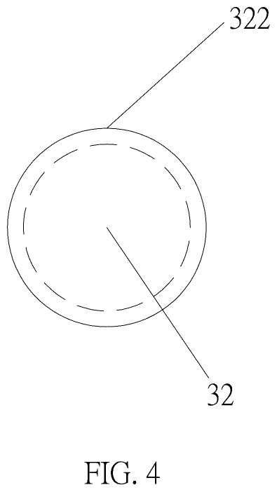

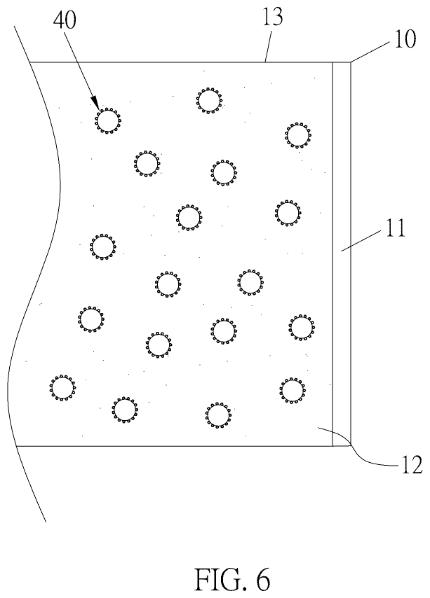

With reference to FIGS. 1 to 6, the present invention provides a composite electrode particle 40 coated with a granular silicon structure, a carbon layer and zinc oxide, which is used in a negative (−) electrode 10 of a solid-state or semi-solid battery. Referring to FIG. 6, the negative electrode 10 includes a negative electrode substrate 11 for carrying the material of the negative electrode 10, and a negative electrode slurry layer 13 coated on the negative electrode substrate 11. The negative electrode slurry layer 13 includes a plurality of composite electrode particles 40 and a negative electrode slurry 12 having a binder. A weight percentage of the composite electrode particles 40 in the negative electrode slurry layer 13 is 90 wt %˜99 wt %. A size of each of the composite electrode particles 40 is 5 μm to 12 μm.

The composite electrode particle 40 includes the following elements.

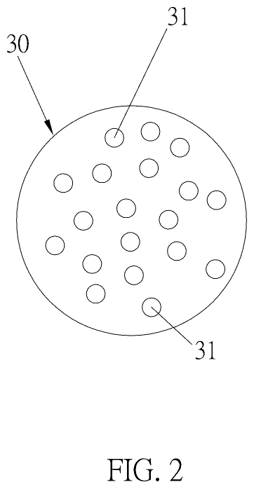

A porous carbon particle 30 has a plurality of holes 31 (as shown in FIG. 2). A size of the porous carbon particle 30 is 5 μm to 10 μm. The porous carbon particle 30 may be formed by graphite.

The carbon layer of the present invention is an amorphous carbon layer 36 coated on an outer surface of the porous carbon particle 30. The amorphous carbon layer 36 is a continuous structure (which is a film layer with a smooth outer surface) formed by amorphous carbon. A radial thickness of the amorphous carbon layer 36 is 10 nm to 20 nm. The amorphous carbon layer 36 has a high conductivity and serves to inhibit an expansion of the composite electrode particle 40 to prevent the composite electrode particle 40 from rupturing due to a volumetric expansion when the lithium ions fill on the composite electrode particle 40. The amorphous carbon of the amorphous carbon layer 36 is selected from hard carbon or soft carbon formed by a de-esterification in sintering of organic resins or organic carbohydrates. The amorphous carbon layer 36 serves to protect the composite electrode particle 40.

A plurality of silicon particles 32 are dispersed within the amorphous carbon layer 36. Referring to FIGS. 1, 3 and 4, an outer surface of a part of the silicon particles 32 is coated with a silicon oxide layer 322 formed by SiOₓ, wherein 0<x≤2. The plurality of silicon particles 32 form a discontinuous structure, wherein the silicon particles 32 on an outer side of the amorphous carbon layer 36 form an island-shaped structure having plural protruded portions, the silicon particles 32 on an inner side of the amorphous carbon layer 36 are attached on the outer surface of the porous carbon particle 30, and the silicon particles 32 between the outer side and the inner side of the amorphous carbon layer 36 are suspended in the amorphous carbon layer 36 without contacting the porous carbon particle 30.

A size of each of the silicon particles 32 is 10 nm to 30 nm. A thickness of the silicon oxide layer 322 is less than 3 nm. The silicon oxide layer 322 is formed by grinding or combustion in manufacturing of the composite electrode particle 40. A ratio of a total weight of the silicon particles 32 and a weight of the porous carbon particle 30 is 1:9 to 1:12.

In the chemical reaction of the battery, the lithium ions will enter into the silicon particles 32 to expand the size of the silicon particle 32, wherein the expanded size may be up to 400 times the original size of the silicon particle 32. Therefore, the size of the composite electrode particles 40 will change dramatically. The holes 31 of the porous carbon particle 30 serve to receive the expanded silicon particles 32.

The conductivity of the silicon oxide layer 322 is lower than that of the silicon particle 32. When the lithium ions pass the silicon particles 32 to expand the size of the silicon particles 32, the huge size expansion of the silicon particles 32 will damage the composite electrode particle 40. The coefficient of thermal expansion of the silicon oxide layer 322 is lower than that of the silicon particle 32 and the binding ability of the silicon oxide layer 322 is better than that of the silicon particle 32, which inhibits the expansion of the composite electrode particle 40 to prevent the composite electrode particle 40 from rupturing.

A zinc oxide (ZnO) layer 37 is coated on an outer side of the amorphous carbon layer 36. The zinc oxide layer 37 is a continuous structure (which is a film layer with a smooth outer surface) formed by a plurality of zinc oxide particles 38. The porous carbon particle 30, the amorphous carbon layer 36, the silicon particles 32 and the zinc oxide layer 37 form the composite electrode particle 40. A radial thickness of the zinc oxide layer 37 is 8 nm to 12 nm. The zinc oxide layer 37 has a high conductivity and has a specific ductility similar to that of metals. When the lithium ions fill the silicon particles 32 and expand the size of the silicon particles 32, the zinc oxide layer 37 serves to protect the structure inside by the high ductility and to keep an integrity of the composite electrode particle 40.

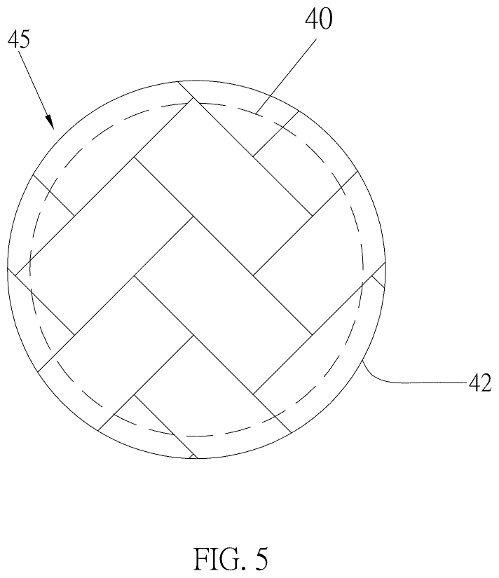

Referring to FIG. 5, an outer side of the composite electrode particle 40 is further wrapped by a plurality of carbon nanotubes 42 to form a carbon-nanotubes-coated composite electrode particle 45. A size of each of the carbon nanotubes 42 is less than 5 μm.

The carbon nanotubes 42 have a high conductivity. The carbon-nanotubes-coated composite electrode particle 45 has a yarn-ball-like structure (as shown in FIG. 5). The carbon nanotubes 42 serve to enhance the electrical conductivity to cause that the electrons can be conducted on the composite electrode particle 40. The carbon nanotubes 42 further serve to conducting the lithium ions to cause that the lithium ions can be conducted between different composite electrode particles 40 in the electrode, which increases the electrical conductivity and ion conductivity of the electrode.

A ratio of a total weight of the carbon nanotubes 42 and a weight of the composite electrode particle 40 is 1:99 to 0.2:99.8.

The advantages of the present invention are that the silicon particles and the amorphous carbon layer are coated on the outer surface of the porous carbon particle. The silicon particles coated with the silicon oxide layer has a lower coefficient of thermal expansion and has a high binding ability, which inhibits the expansion of the composite electrode particle to prevent the composite electrode particle from rupturing. The amorphous carbon layer has a high conductivity and serves to inhibit an expansion of the composite electrode particle to prevent the composite electrode particle from rupturing due to a volumetric expansion when the lithium ions fill on the composite electrode particle. The outer side of the amorphous carbon layer is further coated with the zinc oxide layer which has a high conductivity and has the ductility similar to that of metals. When the lithium ions fill the silicon particles and expand the size of the silicon particles, the zinc oxide layer serves to protect the structure inside by the high ductility. As a result, by above multi-layer coating structure, the breakage rate of composite electrode particle can be greatly reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A composite electrode particle coated with a granular silicon structure, a carbon layer and zinc oxide; the composite electrode particle being used in an electrode of a solid-state or semi-solid battery; the composite electrode particle comprising:
a porous carbon particle having a plurality of holes;
the carbon layer being an amorphous carbon layer coated on an outer surface of the porous carbon particle; the amorphous carbon layer being a continuous structure formed by amorphous carbon; the amorphous carbon layer serving to inhibit an expansion of the composite electrode particle to prevent the composite electrode particle from rupturing when lithium ions fill on the composite electrode particle;
a plurality of silicon particles are dispersed within the amorphous carbon layer; an outer surface of a part of the silicon particles being coated with a silicon oxide layer formed by SiOₓ, wherein 0<x≤2; and
the zinc oxide (ZnO) layer being coated on an outer side of the amorphous carbon layer; the zinc oxide layer is a continuous structure formed by a plurality of zinc oxide particles; and wherein when the lithium ions fill the silicon particles and expand the size of the silicon particles, the zinc oxide layer serves to protect the composite electrode particle by a specific ductility to keep an integrity of the composite electrode particle.

2. The composite electrode particle coated with the granular silicon structure, the carbon layer and the zinc oxide as claimed in claim 1, wherein the plurality of silicon particles form a discontinuous structure, wherein the silicon particles on an outer side of the amorphous carbon layer form an island-shaped structure having plural protruded portions, the silicon particles on an inner side of the amorphous carbon layer are attached on the outer surface of the porous carbon particle, and the silicon particles between the outer side and the inner side of the amorphous carbon layer are suspended in the amorphous carbon layer without contacting the porous carbon particle.

3. The composite electrode particle coated with the granular silicon structure, the carbon layer and the zinc oxide as claimed in claim 1, wherein a size of the porous carbon particle is 5 μm to 10 μm.

4. The composite electrode particle coated with the granular silicon structure, the carbon layer and the zinc oxide as claimed in claim 1, wherein a size of each of the silicon particles is 10 nm to 30 nm; and a thickness of the silicon oxide layer is less than 3 nm.

5. The composite electrode particle coated with the granular silicon structure, the carbon layer and the zinc oxide as claimed in claim 1, wherein a ratio of a total weight of the silicon particles and a weight of the porous carbon particle is 1:9 to 1:12.

6. The composite electrode particle coated with the granular silicon structure, the carbon layer and the zinc oxide as claimed in claim 1, wherein a radial thickness of the amorphous carbon layer is 10 nm to 20 nm.

7. The composite electrode particle coated with the granular silicon structure, the carbon layer and the zinc oxide as claimed in claim 1, wherein the amorphous carbon of the amorphous carbon layer is selected from hard carbon or soft carbon formed by a de-esterification in sintering of organic resins or organic carbohydrates.

8. The composite electrode particle coated with the granular silicon structure, the carbon layer and the zinc oxide as claimed in claim 1, wherein a radial thickness of the zinc oxide layer is 8 nm to 12 nm.

9. The composite electrode particle coated with the granular silicon structure, the carbon layer and the zinc oxide as claimed in claim 1, wherein the composite electrode particle is used in a negative electrode of the solid-state or semi-solid battery.

10. The composite electrode particle coated with the granular silicon structure, the carbon layer and the zinc oxide as claimed in claim 1, wherein an outer side of the composite electrode particle is wrapped by a plurality of carbon nanotubes to form a carbon-nanotubes-coated composite electrode particle.

11. The composite electrode particle coated with the granular silicon structure, the carbon layer and the zinc oxide as claimed in claim 10, wherein a size of each of the carbon nanotubes is less than 5 μm; and the carbon-nanotubes-coated composite electrode particle has a yarn-ball-like structure.

12. The composite electrode particle coated with the granular silicon structure, the carbon layer and the zinc oxide as claimed in claim 10, wherein a ratio of a total weight of the carbon nanotubes and a weight of the composite electrode particle is 1:99 to 0.2:99.8.
